(19) United States
(12) Patent Application Publication
(10) Pub. No.: US 2006/0200461 A1
(43) Pub. Date: Sep. 7, 2006

(54) PROCESS FOR IDENTIFYING WEIGHTED CONTEXTURAL RELATIONSHIPS BETWEEN UNRELATED DOCUMENTS

(76) Inventors: Marshall D. Lucas, Edmond, OK (US); Joseph S. Rosenthal, Rehoboth, MA (US); Don M. Lucas, Bronx, NY (US)

Correspondence Address: BARLOW, JOSEPHS & HOLMES, LTD., 101 DYER STREET, 5TH FLOOR, PROVIDENCE, RI, 02903, US

(21) Appl. No.: 11/275,771

(22) Filed: Jan. 27, 2006

Related U.S. Application Data
(60) Provisional application No. 60/657,745, filed on Mar. 1, 2005.

(51) Int. Cl. G06F 17/30

(52) U.S. Cl. 707/5

(57) ABSTRACT

A system that builds a network using a document collection wherein the documents are collected and represented as a plurality of nodes in a network matrix. The documents that are to be analyzed are bound to the network (corpus) at a discrete node corresponding to the document. The documents are then analyzed to determine term frequency within each document and the overall term frequency of the same term throughout the entire document grouping. This creates a weighting value that determines the relevancy of each document as compared to the entire network of documents. Finally, weighting values are normalized with relative weighting values so that the sum of the weights of all edges connected to a given node equals 1. User queries then proceed through the network from node to node using the algorithm of the present invention to locate documents relevant to the search.

### CROSS-REFERENCE TO RELATED APPLICATIONS

This application is related to and claims priority from earlier filed U.S. Provisional Patent Application No. 60/657,745, filed Mar. 1, 2005, the contents of which are incorporated herein by reference.

### BACKGROUND OF THE INVENTION

The present invention relates generally to a system for identifying interrelationships between unrelated documents. More specifically, the present invention relates to a system that automatically identifies certain qualities within various unrelated documents, weights the relative frequency of these qualities and constructs an interrelated network of documents by drawing relationship links between the documents based on the strength of the weighted qualities within each document. For example, the documents may be analyzed to determine the frequency with which each word appears in a particular document relative to its overall frequency of use in all of the documents of interest. Relationships would then be created between each of the documents that had similar weighted usage of particular words.

In general, the basic goal of any query-based document retrieval system is to find documents that are relevant to the user's input query. It is important and highly desirable, therefore, to provide a user with the ability to identify various bases for relationships between unrelated documents when compiling large quantities of electronic data. Without the ability to automatically identify such relationships, often the analysis of large quantities of data must generally be performed using a manual process. This type of problem frequently arises in the field of electronic media such as on the Internet where a need exists for a user to access information relevant to their desired search without requiring the user to expend an excessive amount of time and resources searching through all of the available information. Currently, when a user attempts such a search, the user either fails to access relevant articles because they are not easily identified or expends a significant amount of time and energy to conduct an exhaustive search of all of the available articles to identify those most likely to be relevant. This is particularly problematic because a typical user search includes only a few words and the prior art document retrieval techniques are often unable to discriminate between documents that are actually relevant to the context of the user search and others that simply happen to include the query term.

In this context, typical prior art search engines for locating unstructured documents of interest can be divided into two groups. The first is a keyword-based search, in which documents are ranked on the incidence (i.e., the existence and frequency) of keywords provided by the user. The second is a categorization-based search, in which information within the documents to be searched, as well as the documents themselves, is pre-classified into “topics” that are then used to augment the retrieval process. The basic keyword search is well suited for queries where the topic can be described by a unique set of search terms. This method selects documents based on exact matches to these terms and then refines searches using Boolean operators (and, not, or) that allow users to specify which words and phrases must and must not appear in the returned documents. However, unless the user can find a combination of words appearing only in the desired documents, the results will generally contain an overwhelming and cumbersome number of unrelated documents to be of use.

Several improvements have been made to the basic keyword search. Query expansion is a general technique in which keywords are used in conjunction with a thesaurus to find a larger set of terms with which to perform the search. Query expansion can improve document recall, resulting in fewer missed documents, but the increased recall is usually at the expense of precision (i.e., results in more unrelated documents) due in large part to the increased number of documents returned. Similarly, natural language parsing falls into the larger category of keyword pre-processing in which the search terms are first analyzed to determine how the search should proceed. For example, the query “West Bank” comprises an adjective modifying a noun. Instead of treating all documents that include either “west” or “bank” with equal weight, keyword pre-processing techniques can instruct the search engine to rank documents that contain the phrase “west bank” more highly. Even with these improvements, keyword searches may fail in many cases where word matches do not signify overall relevance of the document. For example, a document about experimental theater space is unrelated to the query “experiments in space” but may contain all of the search terms.

It is important to note that many of the prior art categorization techniques use the term “context” to describe their retrieval processes, even though the search itself does not actually employ any contextual information. U.S. Pat. No. 5,619,709 to Caid et. al. is an example of a categorization method that uses the term “context” to describe various aspects of their search. Caid's “context vectors” are essentially abstractions of categories identified by a neural network; searches are performed by first associating, if possible, keywords with topics (context vectors), or allowing the user to select one or more of these pre-determined topics, and then comparing the multidimensional directions of these vectors with the search vector via the mathematical dot product operation (i.e., a projection). However in operation, this process is identical to the keyword search in which word occurrence vectors are projected in conjunction with a keyword vector. These techniques therefore should not be confused with techniques that actually employ contextual analysis as the basis of their document search engines,

Another technique that attempts to improve the typical results from a key word based searching system is categorization. Categorization methods attempt to improve the relevance by inferring “topics” from the search terms and retrieving documents that have been predetermined to contain those topics. The general technique begins by analyzing the document collection for recognizable patterns using standard methods such as statistical analysis and/or neural network classification. As with all such analyses, word frequency and proximity are the parameters being examined and/or compiled. Documents are then “tagged” with these patterns (often called “topics” or “concepts”) and retrieved when a match with the search terms or their associated topics have been determined. In practice, this approach performs well when retrieving documents about prominent (i.e., statistically significant) subjects. Given the sheer number of possible patterns, however, only the strongest correlations can be discerned by a categorization method. Thus, for searches involving subjects that have not been pre-defined, the subsequent search typically relies solely upon the basic keyword matching method is susceptible to the same shortcomings.

In an effort to further enhance keyword searching and improve its overall reliability and the quality of the identified documents, a number of alternate approaches have been developed for monitoring and archiving the level of interest in documents based on the key word search that produced that document result. Some of these methods rely on interaction with the entire body of users, either actively or passively, wherein the system quantifies the level of interest exhibited by each user relative to the documents identified by their particular search. In this manner, statistical information is compiled that in time assists the overall network to determine the weighted relevance of each document. Other alternative methods provide for the automatic generation and labeling of clusters of related documents for the purpose of assisting the user in identifying relevant groups of documents.

Yet another method that is utilized to facilitate identification of relevant documents is through prediction of relevant documents utilizing a method known as a spreading activation technique. Spreading activation techniques are based on representations of documents as nodes in large intertwined networks. Each of the nodes include a representation of the actual document content and the weighted values of the frequency of each portion of the relevant content found within the document as compared to the entire body of collected documents. The user requested information, in the form of key words, is utilized as the basis of activation, wherein the network is entered (activated) by entering one or more of the most relevant nodes using the keywords provided by the user. The user query then flows or spreads through the network structure from node to node based on the relative strength of the relationships between the nodes.

While spreading activation provides a great improvement in the production of relevant documents as compared to the traditional key-word searching technique alone, the difficulty in most of these prior art predicting and searching methods is that they generally rely on the collection of data over time and require a large sampling of interactive input to refine the reliability and therefore the overall usefulness of the system. As a result, such systems do not reliably work in smaller limited access networks. For example, when a limited group of people is surveyed to determine particular information that may be relevant to them, the survey in itself is generally limited in scope and breadth. Further, the analysis of the survey needs to be performed without then requesting that the participants themselves pour over the survey data to draw the connections and relevant interrelationships.

Therefore, there is a need for an automatic system for analyzing discrete groups of relevant documents to create an interrelated relevance network that identifies various similarities and interrelationships thereby allowing the data to be correlated in a meaningful manner. There is a further need for an automated system for analyzing discrete groups of documents to create an interrelated document network that is based on the actual contextual use of the search terms within the overall document network. There is still a further need for an automated system for analyzing discrete groups of documents to create an interrelated document network wherein the network is created without the need for user input or organization.

### BRIEF SUMMARY OF THE INVENTION

In this regard, the present invention provides a system for analyzing a discrete group of unrelated input (documents) in a manner that draws semantically and contextually based connections between the documents in order to quickly and easily identify underling similarities and relationships that may not be immediately visible upon the face of the base documents. The present invention provides a unique system that has broad applicability in areas such as counterterrorism, consumer survey data analysis, psychological profiling or any other area were a range of unrelated information needs to be quickly reviewed and distilled to identify patterns or relationships.

The input for analysis in accordance with the system of the present invention is represented in the form of a large group of unrelated documents. This input may be email correspondence between suspected terrorists, a set of answers provided by a person in response to a targeted survey, pharmaceutical testing results or any other set of unrelated data that a user may desire to analyze in order to determine the existence of underlying threads, interrelationships or similarities. Each piece of information in the group of documents is then ultimately representationally referred to as a discrete document.

The present invention provides a system that builds on the concept of spreading activation networks wherein the document collection is then in turn collected and represented as a plurality of nodes in a network matrix. The documents that are to be analyzed are each added into the overall network (corpus) wherein each document is added at a discrete node corresponding to the document. These nodes are referred to as a document node. As the documents are added to the corpus, a stepwise refinement process is utilized that creates a list of terms which were identified from within the document itself in order to connect that document into the network. Each of these terms is also represented as a discrete node within the network referred to as a term node. The terms nodes accordingly serve as the anchors by which each document node is bound to the network.

When analyzing each document in preparation for binding into the corpus, the term frequency within a document is stored as the initial edge weight between that particular term node and the document node. Once the entire corpus is complete the term frequency within the entire corpus is also calculated to provide an overall term frequency that can be utilized to go back to each term node in order to calculate local and global weighting that is applied to the initially calculated edge weights. Finally, the edge weights are normalized with relative weighting values so that the sum of the weights of all edges connected to a given node equals 1.

Once the network is built and all edges have been properly preconditioned by normalizing all of the nodes, the network can then be entered for searching by activating a selected node and allowing the activation value to propagate throughout the network according to a set of predetermined, entropic, rules. While this process of activation is similar to prior art spreading activation type networks, it is the weighting at the relative nodes and the propagation rules that serve to differentiate the present invention from the prior art. Any nodes that remain active once the activation spreading process is complete are gathered and presented as the results of the search. Activation continues thusly until a predetermined entropic threshold is met. Once activation is completed, the gathering process collects all the nodes that have residual activation values (activation values greater than the precondition values) and returns them as a list with their constituent total activation value. The resultant gathered documents that are particularly relevant to a given search form a cluster of semantically and thematically related documents.

In this manner it can be seen that the formation of the collection of documents and the binding of the collection of documents into the corpus in accordance with the system of the present invention is accomplished in an automated fashion. The system of the present invention provides a corpus that instantly includes the necessary contextual information and document weighting to provide meaningful searching without the need for a great deal of user input and analysis.

It is therefore an object of the present invention to provide a system for analyzing a collection of unrelated documents that arranges the documents based on contextual similarities while also allowing dynamic searching of the group of documents. It is a further object of the present invention to provide an automated system that binds each document within a plurality of unrelated documents into a network that identifies the relative strength of contextual interrelatedness between each of the documents within the group. It is yet a further object of the present invention to provide an automated system that binds each document within a plurality of unrelated documents to a searchable network based on the strength of contextual relatedness between each of the documents while eliminating the need for user analysis to determine those contextual relations. It is still a further object of the present invention to provide a system whereby a plurality of unrelated documents are each bound to a network using a node value that is weighted based on the contextual relevance of the document and normalized based on the relevance of the document as compared to the overall network of documents.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying descriptive matter in which there is illustrated a preferred embodiment of the invention.

### DETAILED DESCRIPTION OF THE INVENTION

Turning now to the system of the present invention in detail, an embodiment of a computer based method and apparatus is described for identifying interrelationships between documents within a grouping of a plurality of unrelated documents. Within the context of the present invention it should be noted that the system and apparatus of the present invention is particularly suited for quickly analyzing any group of unrelated documents to identify and develop a relational structure by which the documents can be organized and subsequently searched.

Further, within the scope of the present invention the term document is meant to be defined in a broad sense to include any collection of unstructured text or phrases such as for example, internet web pages, email correspondences, survey results, collections of data and should also be defined to include collections of photographs or other graphics. Ultimately the term document should mean any unstructured collection of data that a user is in need of structuring for the purpose of conducting a search. The method of the present invention also endeavors to improve the quality of the overall structure that is provided by culling out and eliminating documents during an initial step wherein documents that lack sufficient textural content for proper indexing are removed from the overall document collection. This step is particularly useful in eliminating documents such as links farms from the search results once the corpus has been completed.

In this regard, the present invention provides a method for introducing structure to a collection of unstructured documents to facilitate searching of the documents and the identification of underlying relationships that exist between the documents. The method provides for assembling a plurality of unrelated documents into a group for analysis. Once the documents have been assembled into a corpus for processing, a quality of interest is determined by performing an initial search of the documents. The quality of interest may be a word, a phrase or some other identifiable characteristic within each of the documents. It is of further note that the quality or qualities of interest that are utilized in the method of the present invention are not qualities that are pre-assigned or brought to the corpus from the outside, but ate qualities of interest that are identified as being relevant to the document grouping based on an initial analysis of the corpus of documents. The documents that are to be analyzed are then each added into the overall network (corpus) wherein each document is added at a discrete node corresponding to the document. These nodes are referred to as a document node. Further, the qualities of interest that are identified are utilized as term nodes that are then arranged wherein each of these terms is also represented as a discrete node within the network. The terms nodes accordingly serve as the anchors by which each document node is bound to the network and is utilized as a binding point for each of the documents within the plurality of documents. Accordingly, as each of the documents are added to the corpus, a stepwise refinement process is utilized that creates a list of terms which were identified from within the document itself in order to connect that document node into the network via term nodes. The frequency of each quality of interest within the document being analyzed is then stored as an initial edge weight between that particular term node and the document node.

In addition to calculating the frequency of the quality of interest within each of the documents, the frequency of the quality of interest is also calculated for the overall corpus. This overall frequency value is then utilized to go back to each term node at each document in order to calculate local and global weighting that is applied to the initially calculated edge weights. Finally, the edge weights are normalized with relative weighting values so that the sum of the weights of all edges connected to a given node equals 1. In this manner, relationship links can be generated based on the normalized node values to determine the overall relative strength between the term nodes as they relate to each of the documents of interest.

Once the nodes are built a pass is made against the entire node network of the corpus to determine the overall term counts and store them for use in generating the initial view of the node network by taking the top 10 terms as a search query (i.e. generating the relevant qualities of interest). A search is performed against the index by “injecting” a set amount of energy into the network at a specific node point and allowing that energy to propagate to each constituent node according to the edge weight connecting the nodes. Once a predetermined entropic value is reached, the search ends. This can be done multiple times, once for each quality of interest, and the combined energy at the end of this process is used to gather the nodes that have achieved a preset boundary limit. The documents that are so gathered are then returned as the result set of the search.

It should be noted that the edge weights for each of the nodes are determined by the following formula, calculated on the fly (in contrast to the prior art systems that pre-calculate edge weights). Accordingly the formula is as follows:

$${w}_{t , d} = α + ( 1 - α ) \frac{f}{f + 0.5 + K L} ( \frac{ln ( \frac{N + 0.5}{n} )}{ln ( N + 1 )} )$$

Wherein:
α=0.4
K=1.5
L=1
f≡TermFrequency
N≡TotalDocumentCount
n≡TermDocumentFrequency

To further enhance the quality of relationships generated when binding documents to the corpus, the qualities of interest that are utilized are more than simply a single word search term. The quality of interest may also include a phrase. Further, the method of the present invention utilizes a Natural Language Processor that provides for generating a relevant quality of interest based on the initial search term, roots of the term, thesaurus equivalents of the term, and roots of the thesaurus equivalents of the term. It can be seen that by processing each quality of interest in this manner, a much higher degree of relevancy can be achieved while also enabling the search to identify documents that would not be obtained using any of the prior art searching algorithms.

Once the corpus is completed it is prepared for searching. A user enters the corpus and searches the plurality of documents using one of the identified qualities of interest via an entropic algorithm wherein the scope of the search is limited by dissipation of an initial activation value. Ultimately the dissipation of entropy is determined by subtracting the weighting value of each relationship link followed in the search from the initial activation value.

The propagation rules utilized in the present invention include three specific principals that serve to distinguish the present network analysis tool from a prior art spreading activation network model such as Contextual Network Graphs. First, in the present invention, the activation value is limited in order to guarantee that the network will move toward an increasingly stable, asymptotic, state. In other words, the relative correlation threshold is adjustable as desired by the user thereby allowing the user to control the strength of relativity between documents and terms that is required before allowing further activation. This can be contrasted with prior art spreading activation networks that simply determined an activation decay value that ultimately terminated the activation spread. Second, activation reflection is not allowed. This means that any given edge cannot be traversed sequentially. If passing from a document node to a term node, the activation cannot then return to the document that it just left, the document must be skipped on the next activation round as the activation passes from a term node to the next group of relevant documents. In this manner, activation is required to pass from document to term to new document or from term to document to new term. Finally, term nodes are analyzed using a lexicon that processes synonyms for each term node using the same activation value as the term node itself. This allows relevant term nodes to be identified even if the terms are not an identical match to the search terminology.

It is of particular note that by applying local and global weighting to the edges creates a probabilistic network of preconditions between nodes. The creation of the probability weighted term nodes provides a replacement for the need to have interactivity with a user group in order to develop a probability history over time. In this manner, when the corpus is completed and the network is built the nodes already include probability weighting so that node selection leads to decision-theoretic planning. In other words the need for user interaction over time to insure that only high probability nodes are activated has been eliminated. In the present invention, a user can be assured that from the outset the activation of a node is the product of the probabilities of correlation of subsequent nodes in the path. This also causes document nodes to become basic “quanta” of knowledge within the corpus. Further, any node may activate one or more nodes, excluding only the node that initially activated the current node (thus preventing reflection).

The entire method of the present invention is directed at a computer-based solution for the collecting and structuring of unstructured information. In this manner the principal implementation of the present invention would be via a computer device in some form. In the simplest form, the computer may be standalone with a display, user interface, processor and storage memory that are all maintained locally. In other embodiments, the system for use in conjunction with the method of the present invention may be far more complex and spread across a global computer network such as the internet or any other wide are network arrangement. Further, various functions of the process may be separated and performed at various locations across the network. A user for example may access a remote computer processor that in turn searches for the documents that are to added to the corpus by searching a plurality of other interconnected servers. Simply put, the actual implementation of the method of the present invention could easily be distributed across a broad area yet still fall within the spirit and scope of the present disclosure.

It can therefore be seen that the present invention provides a novel method and system for analyzing a large group of unrelated documents in an automated manner such that a network structure is generated thereby introducing structure information to enable the documents to be analyzed and searched in a meaningful way. Further the present invention provides a method of introducing structure to a large group of unstructured documents in a manner that eliminates the need for large amounts of user input and/or analyst time to create meaningful and context based search keys. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A computer based method for identifying interrelationships between documents within a grouping of a plurality of unrelated documents, comprising the steps of:
assembling a plurality of unrelated documents into a group for analysis;
identifying at least one quality of interest to be analyzed;
analyzing the group of documents to determine a first frequency of the at least one quality within the group;
analyzing the group of documents to determine a second set of frequencies corresponding to the frequency of the at least one quality within each individual document;
normalizing each of said second frequencies relative to said first frequency to generate a weighting factor for each of said documents; and
generating relationship links based on said normalized second frequencies corresponding to said at least one quality of interest, said relationship links extending between documents that are weighted relative to the at least one quality of interest.

2. The method of claim 1, wherein said at least one quality of interest comprises a plurality of qualities of interest and said step of generating relationship links includes generating discrete sets of relationship links, each of said sets of links corresponding to each of said qualities of interest within said plurality of qualities of interest.

3. The method of claim 1, further comprising the steps of:
reviewing the content of each of said plurality of documents it identify which of those documents contain sufficient textural content for analysis; and
eliminating documents from said plurality of documents that do not contain sufficient textural content.

4. The method of claim 1, wherein said quality of interest is comprises a plurality of terms, said plurality of terms including a word, roots of said word, thesaurus equivalents of said word, and roots of said thesaurus equivalents of said word.

5. The method of claim 1, further comprising the step of:
searching said plurality of documents using one of said qualities of interest using an entropic algorithm wherein said scope of said search is limited by dissipation of an initial activation value, said dissipation determined by subtracting the weighting value of each relationship link followed in the search from the initial activation value.

6. The method of claim 1 wherein the documents comprise unstructured data.

7. The method of claim 6 wherein the documents comprise free-form text.

8. The method of claim 1 wherein the documents comprise images.

9. The method of claim 2 wherein said plurality of qualities of interest is identified based on the relative frequency of said qualities of interest relative to all of the qualities contained within said plurality of documents.

10. The method of claim 9 wherein said qualities of interest comprise single word entries.

11. The method of claim 9 wherein said qualities of interest terms comprise a phrase.

12. A computer based method for identifying interrelationships between documents within a grouping of a plurality of unstructured and unrelated documents, comprising the steps of:
assembling a plurality of unrelated documents for analysis;
performing an initial analysis of said plurality of documents to identify at least one quality of interest to be analyzed based on the overall content of said plurality of documents;
determining a first frequency corresponding to the frequency of said at least one quality of interest within said plurality of documents;
performing a second analysis of the plurality of documents to determine a second set of frequencies corresponding to the frequency of the at least one quality within each individual document;
normalizing each of said second frequencies relative to said first frequency to generate a weighting factor for each of said documents; and
generating structured data about the unstructured plurality of documents based on said weighting factor.

13. The method of claim 12, wherein said at least one quality of interest comprises a plurality of qualities of interest and said step of generating structured data includes generating discrete sets of structured data corresponding to each of said qualities of interest within said plurality of qualities of interest.

14. The method of claim 12 further comprising the steps of:
reviewing the content of each of said plurality of documents it identify which of those documents contain sufficient textural content for analysis; and
eliminating documents from said plurality of documents that do not contain sufficient textural content.

15. The method of claim 12, wherein said quality of interest is comprises a plurality of terms, said plurality of terms including a word, roots of said word, thesaurus equivalents of said word, and roots of said thesaurus equivalents of said word.

16. The method of claim 12, further comprising the step of:
searching said plurality of documents using one of said qualities of interest using an entropic algorithm wherein said scope of said search is limited by dissipation of an initial activation value by subtracting said weighting values from said initial activation value as said search passes through said structured data.

17. A computer based apparatus for identifying interrelationships between documents within a grouping of a plurality of unrelated documents, comprising:
means for assembling a plurality of unrelated documents into a group for analysis; and
processor means for identifying at least one quality of interest to be analyzed, wherein said processor means first analyzes the group of documents to determine a first frequency of the at least one quality within the group, wherein said processor means then analyzes the group of documents to determine a second set of frequencies corresponding to the frequency of the at least one quality within each individual document, said processor normalizing each of said second frequencies relative to said first frequency to generate a weighting factor for each of said documents to generate relationship links based on said normalized second frequencies corresponding to said at least one quality of interest, said relationship links extending between documents that are weighted relative to the at least one quality of interest.

18. A computer based apparatus for identifying interrelationships between documents within a grouping of a plurality of unstructured and unrelated documents, comprising:
means for assembling a plurality of unrelated documents for analysis;
means for performing an initial analysis of said plurality of documents to identify at least one quality of interest to be analyzed based on the overall content of said plurality of documents;
means for determining a first frequency corresponding to the frequency of said at least one quality of interest within said plurality of documents;
means for performing a second analysis of the plurality of documents to determine a second set of frequencies corresponding to the frequency of the at least one quality within each individual document;
means for normalizing each of said second frequencies relative to said first frequency to generate a weighting factor for each of said documents; and
means for generating structured data about the unstructured plurality of documents based on said weighting factor.
